(19) United States
(12) Patent Application Publication
(10) Pub. No.: US 2015/0004576 A1
(43) Pub. Date: Jan. 1, 2015

(54) APPARATUS AND METHOD FOR PERSONALIZED SENSORY MEDIA PLAY BASED ON THE INFERRED RELATIONSHIP BETWEEN SENSORY EFFECTS AND USER'S EMOTIONAL RESPONSES

(71) Applicant: Electronics and Telecommunications Research Institute, Daejeon-si (KR)

(72) Inventors: Hyun Jin YOON, Daejeon (KR); Sang Wook PARK, Daejeon (KR); Ji Yeon KIM, Daejeon (KR); Yong Kwi LEE, Daejeon (KR); Jong Hyun JANG, Daejeon (KR)

(73) Assignee: Electronics and Telecommunications Research Institute, Daejeon-si (KR)

(21) Appl. No.: 14/224,740

(22) Filed: Mar. 25, 2014

(30) Foreign Application Priority Data
Jun. 26, 2013 (KR) 10-2013-0073621

(51) Int. Cl. G09B 5/06

(52) U.S. Cl. CPC G09B 5/065
USPC 434/236

(57) ABSTRACT

The present invention provides an apparatus and method for personalized sensory media play based on the inferred relationship between sensory effects and user's emotional responses. The apparatus for sensory media play comprises a sensory media playing unit playing sensory media, an emotion inference unit inferring an emotional state of a user based on a compound emotional signal of the user measured at the time of playing the sensory media; and a sensory effect determining unit determining a sensory effect property of the sensory media based on the inferred emotional state of the user, where the sensory media playing unit plays the sensory media according to the sensory effect property determined.

This application claims priority to and the benefit of Korean Patent Application No. 10-2013-0073621 filed on Jun. 26, 2013, which is incorporated by reference in its entirety herein.

### BACKGROUND OF THE INVENTION

1. Field of the Invention

The embodiments of the present invention are related to an apparatus and a method for inferring an emotional state of a user with respect to a sensory effect stimulus applied to the user experiencing sensory media and playing the sensory media for the user to feel satisfaction.

2. Discussion of the Related Art

Sensory media is the next-generation media developed for reproducing the real world as closely as possible; and has an advantage of providing expressive power, a sense of immersion, presence, and reality far superior to those from the existing media consisting of video, audio, and text by employing a sensory effect stimulating five senses of a human.

Sensory media usually refers to multi-sensory contents made by adding sensory effect metadata (SEM) intended for reproducing sensory effects such as motion, wind, vibration, fog, and scent to the existing A/V (Audio/Video) media such as video and game. Sensory effects are reproduced based on the SEM by properly controlling various types of sensory devices such as a motion chair, a fan, a thermostat, vibratory equipment, lighting equipment, and an odor generator through synchronization with A/V media.

Sensory media services in the early days were provided in such a way as to reproduce sensory media produced by a producer at his or her own choice regardless of user preferences, being intended for the whole users. However, since types and strength of sensory effects desired by individual users may vary according to their user type which can be categorized by the user's gender, age, body, illness, and the like; current health state and mental state of the user; or a play environment (at dawn, an indoor or outdoor environment) of the sensory effects, standardized services which do not take into account the user preference cannot satisfy the user's requirements for experiencing diverse sensory effects.

To solve such a problem above, the Korean patent application no. 10-2010-0114857 (published on Oct. 26, 2012) “method and apparatus for representation of sensory effects using user's sensory effect preference metadata” discloses a method for receiving information about a user's preference for sensory effects and controlling playback of sensory media based on the received information.

The method above is capable of providing sensory effects according to the user's preference only when the user specifies his or her preference to sensory effects; for other situations where the user does not provide his or her preference, however, only a predefined reproduction of sensory effects is available. Therefore, the user has to take the trouble to previously provide information about his or her preference to sensory effects for all of play conditions to obtain satisfactory reproduction of sensory media.

As indicated above, the existing technologies require considerable user intervention such as receiving preference information or a command (interaction) for controlling play of sensory media from the user to embody personalized sensory media play; thus, the existing technologies have a limitation that personalized sensory media services may not be continued without appropriate provision of information or control from the user. Also, the existing technologies require exact knowledge about preferred properties of sensory effects from the user.

Therefore, there needs a new technology capable of maximizing the effects of sensory media and maintaining user satisfaction, by playing the sensory media automatically in such a way as to meet the user satisfaction without involving the user's intentional intervention for each time the user experiences sensory effects.

### SUMMARY OF THE INVENTION

The present invention has been made in an effort to provide an apparatus and a method for personalized sensory media play based on emotion inference, capable of playing sensory media for a user experiencing the sensory media to feel satisfaction by estimating a relationship between sensory effects and emotional responses through the emotion inference determining an emotional response of the user to a sensory effect stimulus.

According to one aspect of the present invention, an apparatus for sensory media play comprises a sensory media playing unit playing sensory media, an emotion inference unit inferring an emotional state of a user based on a compound emotional signal of the user measured at the time of playing the sensory media, and a sensory effect determining unit determining a sensory effect property of the sensory media based on the inferred emotional state of the user, where the sensory media playing unit plays the sensory media according to the sensory effect property determined.

In one embodiment, the sensory media comprises A/V (Audio/Video) media and sensory effect metadata for playing sensory effects of the sensory media.

In another embodiment, the sensory effect metadata includes fixed-type property information including sensory effect play time and type of a sensory effect; and variable-type property information including sensory effect play time and strength of the sensory effect.

In a yet another embodiment, the sensory effect determining unit determines the sensory effect property by using pre-stored sensory effect determination rules based on the estimated emotional state of the user, and generates personalized sensory effect metadata by reconfiguring variable-type property information of the sensory effect metadata based on the sensory effect property determined.

In a still another embodiment, the sensory media playing unit plays the sensory media by synchronizing a sensory device playing the sensory effect based on the personalized sensory effect metadata with an A/V device playing the A/V media, and controlling the sensory device.

In a further embodiment, the emotion inference unit infers an emotional state of the user based on the compound emotional signal received at the time of playing the sensory media from a sensing device sensing at least one of motion, voice, and a biometric response of the user.

In a still further embodiment, the emotion inference unit comprises a compound emotional feature extracting unit extracting compound emotional features from the compound emotional signal, an emotion classification model generating unit generating an emotion classification model estimating a relationship between the extracted compound emotional features and emotion, and an emotional response determining unit determining an emotional response of the user to a sensory effect by using the generated emotion classification model.

In an additional embodiment, the emotion inference unit further comprises a user basic information extracting unit extracting basic information of a user including at least one of gender and age group of the user based on an image signal included in the compound emotional signal.

In a yet additional embodiment, the apparatus further comprises an emotional knowledgebase comprising the extracted user basic information, the extracted compound emotional feature, the determined sensory response of the user to a sensory effect, and the generated emotional classification model, which is used at the time of inferring the emotional state of the user; and an emotional knowledgebase comprising the extracted user basic information, information about sensory effects of the sensory media reproduced, information about an emotional response of the user to the sensory effects, a sensory effect determination model for determining the sensory effect, and sensory effect determination rules derived through the sensory effect determination model, which is used at the time of determining the sensory effect property.

According to another aspect of the present invention, a method for a sensory media playing apparatus to play sensory media comprises inferring an emotional state of the user based on a compound emotional signal of the user measured at the time of playing sensory media, determining sensory effect property of the sensory media based on the inferred emotional state of the user, and playing the sensory media according to the sensory effect property determined.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a block diagram illustrating an apparatus for sensory media play according to one embodiment of the present invention;

FIG. 2 is a block diagram illustrating an internal structure of an emotion inference unit of an apparatus for sensory media play according to one embodiment of the present invention;

FIG. 3 illustrates an emotional knowledgebase according to one embodiment of the present invention;

FIG. 4 illustrates a sensory knowledgebase according to one embodiment of the present invention;

FIG. 5 illustrates a sensory effect determination model according to one embodiment of the present invention;

FIG. 6 illustrates sensory effect determination rules according to one embodiment of the present invention;

FIG. 7 is a flow diagram illustrating a method for sensory media play according to one embodiment of the present invention;

FIG. 8 is a flow diagram illustrating a method for initializing an emotional knowledgebase according to one embodiment of the present invention; and

FIG. 9 is a flow diagram illustrating a method for initializing a sensory knowledgebase according to one embodiment of the present invention.

### DETAIL DESCRIPTION OF THE INVENTION

In what follows, embodiments of the present invention will be described in detail with reference to appended drawings in order for those skilled in the art to which the present invention belongs to use the embodiments in an easy manner. However, the present invention can be embodied in various other forms, and is not limited to the embodiments described in this document. To describe the present invention without ambiguity, those parts irrelevant to the description have been omitted from the drawings, and similar drawing symbols are assigned to the elements similar to each other throughout the document.

Throughout the document, if a part is said to “include” a constituting element, it means that the part can further include other constituting elements rather than exclude the other constituting elements unless particularly described otherwise. Also, such a term as a “unit” indicates a unit that processes at least one function or operation, which can be embodied in the form of hardware or software, or a combination of hardware and software.

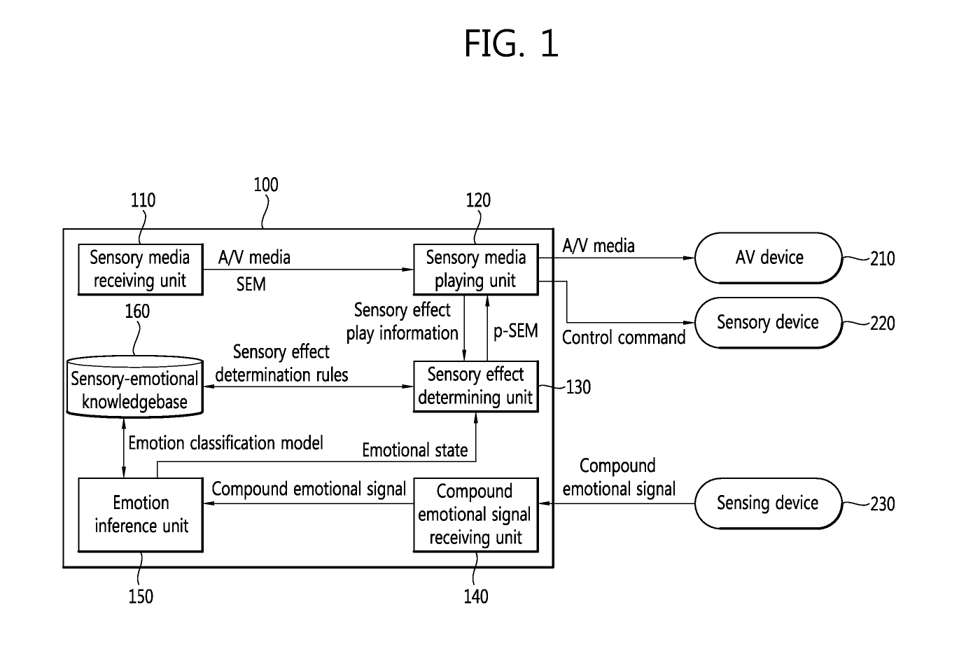

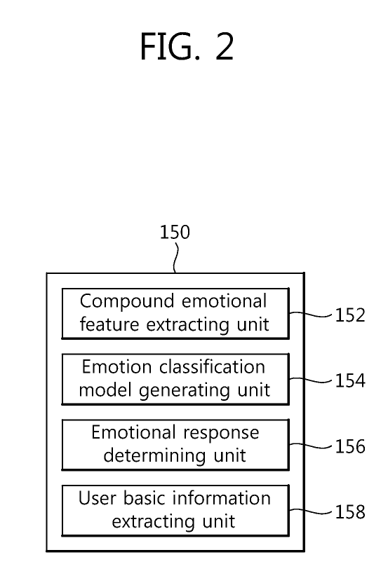

FIG. 1 is a block diagram illustrating an apparatus for sensory media play according to one embodiment of the present invention, and FIG. 2 is a block diagram illustrating an internal structure of an emotion inference unit of an apparatus for sensory media play according to one embodiment of the present invention.

With reference to FIG. 1, an apparatus 100 for personalized sensory media play based on emotion inference according to the present invention comprises a sensory media receiving unit 110, a sensory media playing unit 120, a sensory effect determining unit 130, a compound emotional signal receiving unit 140, an emotion inference unit 150, and a sensory-emotional knowledgebase 160.

The sensory media receiving unit 110 receives sensory media from a media producer, various types of terminals, an external transmission device connected through a network, and the like, and transmits the received sensory media to the sensory media playing unit 120, where the sensory media includes A/V (Audio/Video) media such as video and game; and sensory effect metadata (SEM) required for playing various sensory effects such as motion, wind, vibration, fog, and scent.

The sensory media playing unit 120 plays sensory media by controlling various sensory devices 210 such as a motion chair, a fan, a thermostat, vibratory equipment, lighting equipment, an odor generator, and others through synchronization with an A/V device 220 playing A/V media, where synchronization is carried out based on sensory effect metadata included in the sensory media received from the sensory media receiving unit 110 or personalized sensory effect metadata (p-SEM: personalized SEM) received from the sensory effect determining unit 130. And the sensory media playing unit 120 transmits sensory effect play information of the reproduced sensory media to the sensory effect determining unit 130.

Sensory effect metadata can include sensory effect play time, sensory effect type, sensory effect duration, sensory effect strength, and additional property information for each sensory effect. The sensory effect play time and sensory effect type are classified into fixed-type property information which does not allow change of the initial property value while the remaining properties (sensory effect duration, sensory effect strength, and additional property information for each sensory effect) are classified into variable-type property information which can be changed for the user to experience satisfaction at the time of playing sensory media.

The sensory effect determining unit 130 determines sensory effects according to the user's emotional state by using sensory effect determination rules stored in the sensory-emotional knowledgebase 160 so that the corresponding user experiences satisfaction, generates personalized sensory effect metadata (p-SEM) by reconfiguring variable-type property information of sensory effect metadata according to the determined sensory effects, and transmits the generated p-SEM to the sensory effect playing unit 120.

The user satisfaction can be defined by one of universal emotions such as happiness, sadness, surprise, fear, disgust, anger, excitement, interest, and acceptance; or a combination of the universal emotions depending on the purpose of playing sensory media. For example, in case sensory media to play is a car advertisement, the user satisfaction with respect to the car advertisement may be defined by one of the universal emotions, interest. In this case, the sensory effect determining unit 130 can determine the property of sensory effect stimulus for the user to feel the emotion of interest to the full. On the other hand, in case the user satisfaction with respect to the car advertisement is defined by a compound emotion which is a combination of happiness and interest, the sensory effect determining unit 130 can determine the property of sensory effect stimulus in such a way as to maximize the user's experience of both the emotions of happiness and interest. Also, the sensory effect determining unit 130 can have an additional function of detecting collision between sensory effect determination rules and ensuring consistency between sensory effect determination rules.

The compound emotional signal receiving unit 140 receives a compound emotional signal including image, voice, and biometric signal information from a sensing device 230 sensing motion, voice, biometric response, and so on of the user who is experiencing a sensory effect stimulus; and delivers the received compound emotional signal to the emotion inference unit 500. The sensing device 230 can include a camera, a microphone, an EEG sensor, a pulse wave sensor, and a temperature sensor.

The emotion inference unit 150 estimates the user's emotional state by using a compound emotional signal received from the compound emotional signal receiving unit 140 based on the emotion classification model stored in the sensory-emotional knowledgebase 160.

As shown in FIG. 2, one example of the emotion inference unit 150 can include a compound emotional feature extracting unit 152, an emotion classification model generating unit 154, an emotional response determining unit 156, and a user basic information extracting unit 158.

The compound emotional feature extracting unit 152 receives from a sensing device 239 a compound emotional signal measured while the user is experiencing an emotion through the corresponding stimuli inducing the emotion, and extracts compound emotional features relevant to emotion inference from the received compound emotional signal. The compound emotional signal can include image, voice, and a biometric signal measured by sensing facial expression, whole-body motion, voice, brain wave, and pulse wave of the user.

The emotion classification model generating unit 154 generates an emotion classification model, which is an empirical expression for estimating the relationship between compound emotional features extracted from the compound emotional feature extracting unit 152 and the corresponding emotional state as closely as possible, and stores the generated emotion classification model into the sensory-emotional knowledgebase 160.

The emotional response determining unit 156 determines the user's emotional response to a sensory effect stimulus played by the sensory media playing unit 120 based on the emotion classification model stored in the sensory-emotional knowledgebase 160.

The user basic information extracting unit 158 extracts the user's basic information including gender and age group of the user based on the compound emotional signal received from the compound emotional signal receiving unit 140, and stores the extracted user basic information into the sensory-emotional knowledgebase 160. In one example, the user basic information extracting unit 158 can estimate gender and age group of the user based on an image signal included in the compound emotional signal.

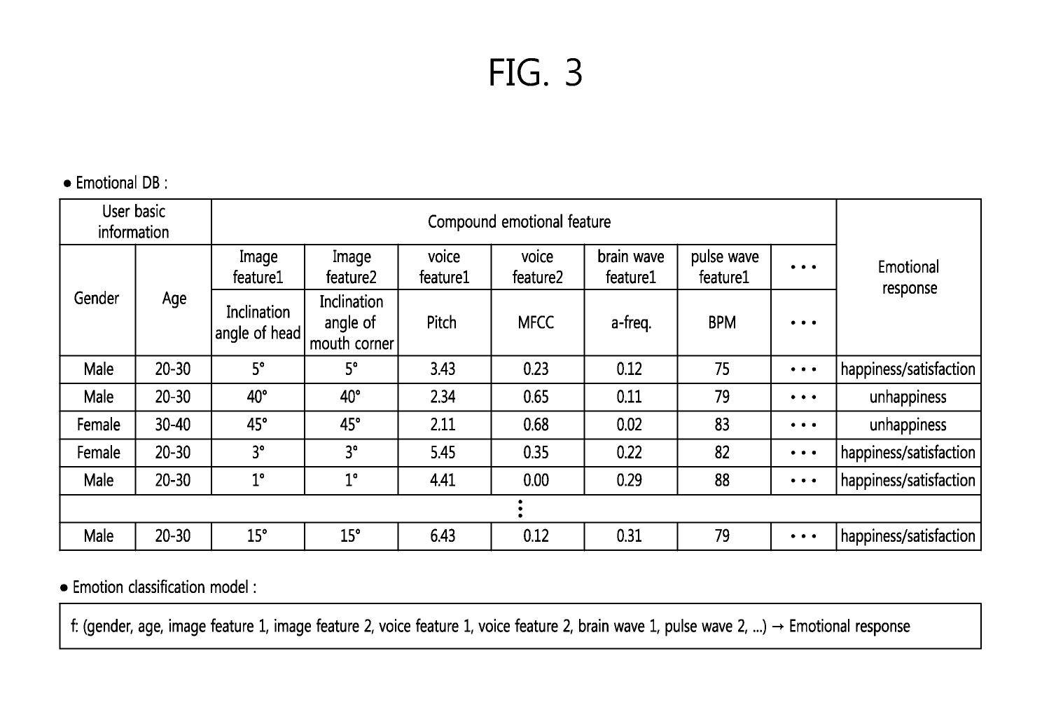

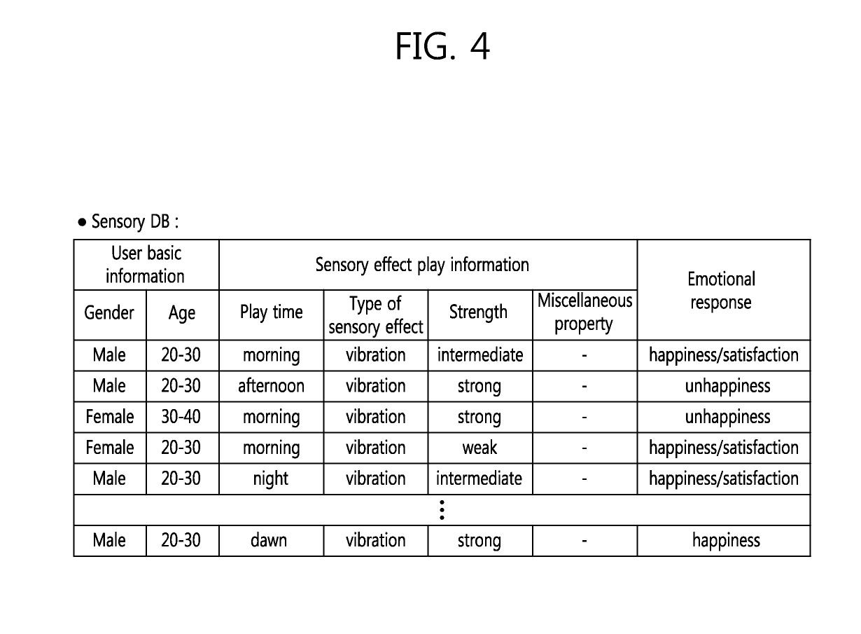

The sensory-emotional knowledgebase 160 includes compound emotional signal information for each emotional state, basic information of the user, sensory effect play information, motion classification model, sensory effect determination rules, and the like. The sensory-emotional knowledgebase 160 can be divided into the emotional knowledgebase 610 used for decision-making of the emotion inference unit 150 and the sensory knowledgebase 620 used for decision-making of the sensory effect determining unit 130. In what follows, the sensory-emotional knowledgebase will be described in more detail with reference to FIGS. 3 and 4.

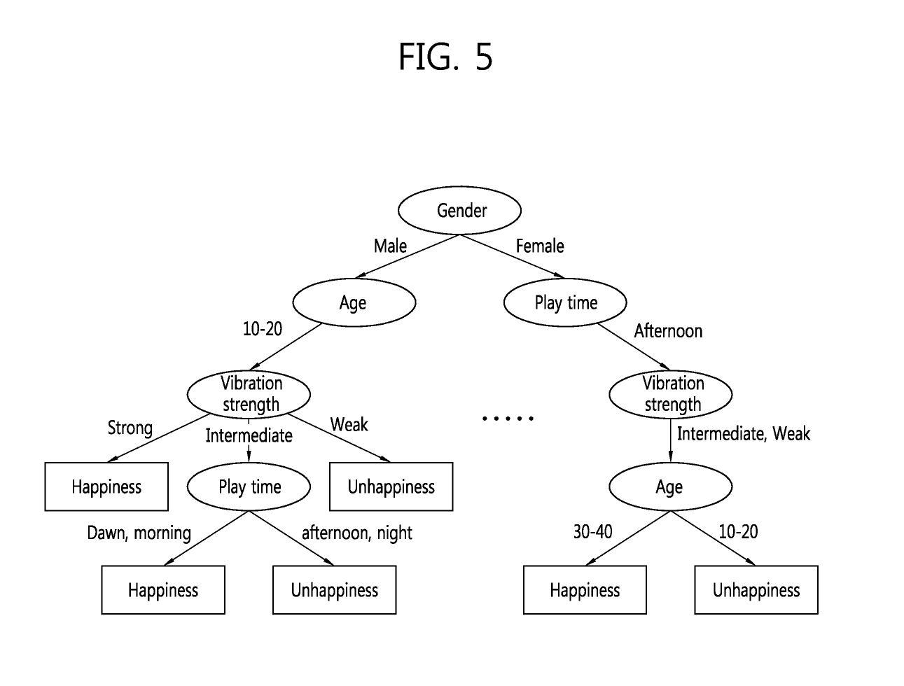

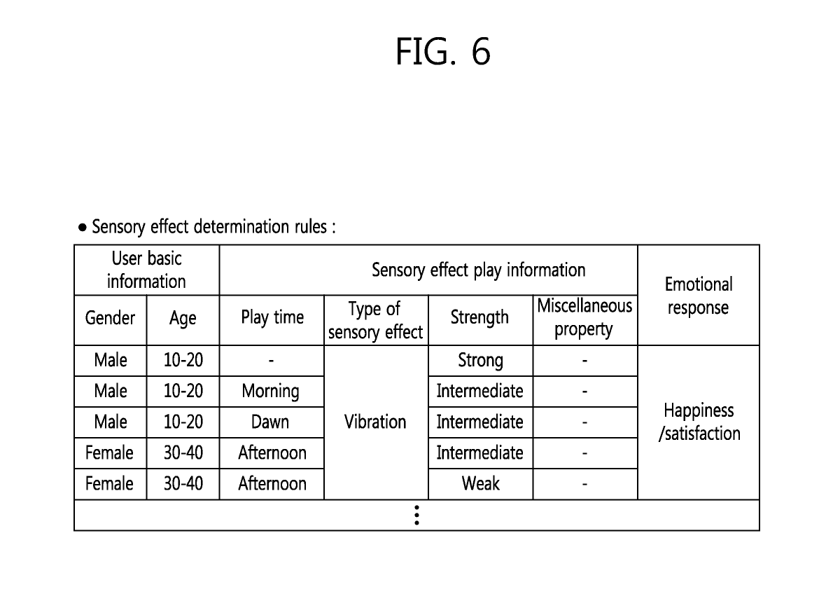

FIG. 3 illustrates an emotional knowledgebase according to one embodiment of the present invention, and FIG. 4 illustrates a sensory knowledgebase according to one embodiment of the present invention. Meanwhile, FIG. 5 illustrates a sensory effect determination model according to one embodiment of the present invention, and FIG. 6 illustrates sensory effect determination rules according to one embodiment of the present invention.

First, with reference to FIG. 3, the emotional knowledgebase includes an emotional database (DB) storing results of extracting compound emotional features from compound emotional signals received from the compound emotional signal receiving unit 140 by the emotion inference unit 150 and an emotion classification model, which is an empirical expression (f) estimating the relationship between compound emotional features stored in the emotional DB and emotional responses. The emotion inferring unit 150 receives a compound emotional signal based on the emotion classification model and determines an emotional response of the user to a sensory effect stimulus. For example, the empirical expression (f) is constructed based on one of regression models such as multiple linear regression, artificial neural network, and support vector machine; and is completed by estimating parameters of the empirical expression constructed from the emotional DB.

Next, as shown in FIGS. 4 to 6, the sensory knowledgebase includes user basic information, sensory effect play information in association with a sensory effect reproduced by the sensory media playing unit 200, a sensory database (DB) comprising inference results of emotional responses of the user experiencing a sensory effect, a sensory effect determination model meant for classifying emotional responses according to the respective sensory effects, user basic information corresponding to a feeling of satisfaction derived from the sensory effect determination model, and sensory effect determination rules used as conditions to meet for playing sensory effects. The sensory effect determination model can be generated based on a decision tree model which takes account of gender and age group of the user, and from which sensory effect determination rules for inducing user satisfaction can be readily derived. The sensory effect determination model of FIG. 5 assumes that the sensory effect is vibration while FIG. 6 illustrates sensory effect determination rules when the sensory effect is vibration.

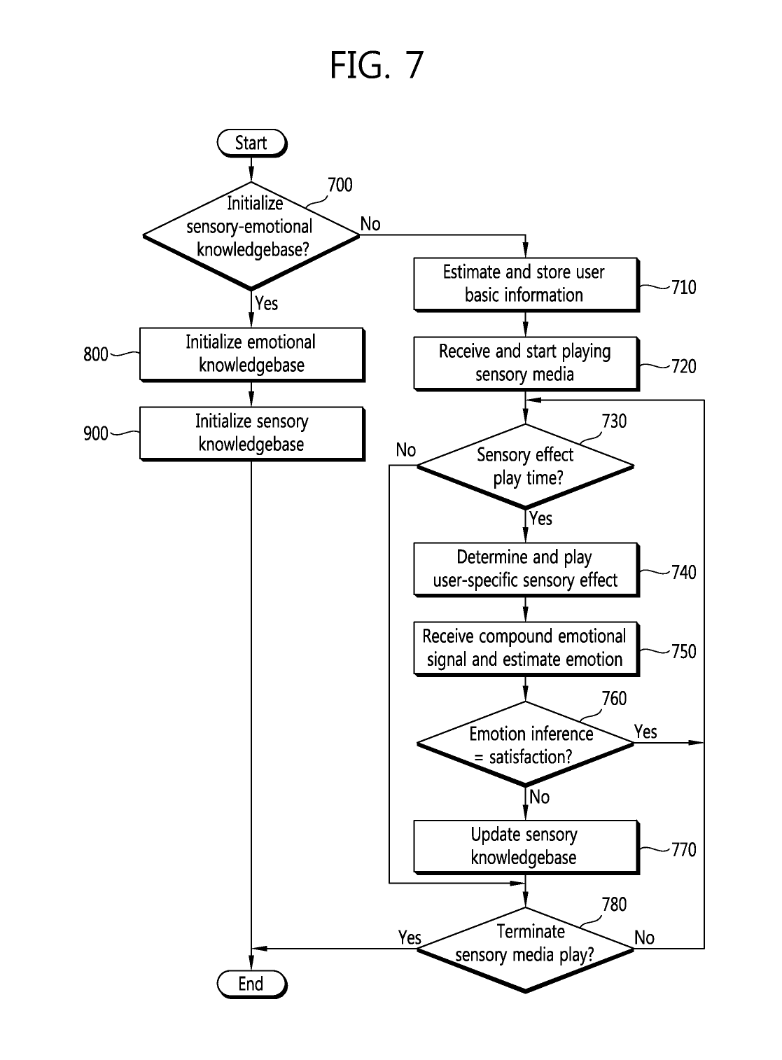

FIG. 7 is a flow diagram illustrating a method for sensory media play according to one embodiment of the present invention.

As shown in FIG. 7, an apparatus for sensory media play according to the present invention can determine whether to initialize the sensory-emotional knowledgebase before playing sensory media 700. In case the sensory-emotional knowledgebase is initialized, the apparatus for sensory media play initializes the emotional knowledgebase 800 by generating the emotional knowledgebase and initializes the sensory knowledgebase 900 by generating the sensory knowledgebase. Once the sensory-emotional knowledgebase is initialized, the apparatus for sensory media play is able to reproduce sensory media based on the constructed sensory-emotional knowledgebase so that the user can experience a feeling of satisfaction.

As one example, in order to play sensory media so that the user can experience a feeling of satisfaction, the apparatus for sensory media play extracts user basic information such as gender and age group of the user based on a compound emotional signal received from a sensing device, stores the extracted user basic information into the sensory-emotional knowledgebase 710, and receives and starts sensory media 720.

While playing sensory media, the sensory media playing unit of the apparatus for sensory media play determines whether the corresponding time is sensory effect play time 730. In case it corresponds to sensory effect play time, the sensory media playing unit can request transmission of personalized sensory effect metadata (p-SEM) from the sensory media determining unit. Receiving a request for personalized sensory effect metadata, the sensory effect determining unit determines a sensory effect by using sensory effect determination rules stored in the sensory knowledgebase so that the user can experience a feeling of satisfaction, and based on the sensory effect, reconfigures variable-type property information of the sensory effect metadata. And the sensory effect determining unit transmits the personalized sensory effect metadata (p-SEM), which is a result of reconfiguration, to the sensory media playing unit so that the sensory media playing unit can control a sensory device based on the personalized sensory effect metadata thereby playing sensory effects 740.

Meanwhile, the compound emotional signal receiving unit of the apparatus for sensory effect play receives a compound emotional signal which senses an emotional response of the user in response to a sensory effect stimulus after the sensory effect is played, and transmits the received compound emotional signal to the emotion inference unit; and the emotion inference unit infers an emotional response of the user based on the emotion classification model stored in the emotional knowledgebase 750. The emotion inference unit determines whether the emotion inference result is a feeling of satisfaction 760, and if the emotional response of the user in response to the sensory effect stimulus is not a feeling of satisfaction, the emotion inference unit updates and stores the sensory DB, sensory effect determination model, and sensory effect determination rules with the recent compound emotional signal, user basic information, sensory effect play information, and emotional response inference result 770. The above procedure can be repeated until sensory media play is terminated 780.

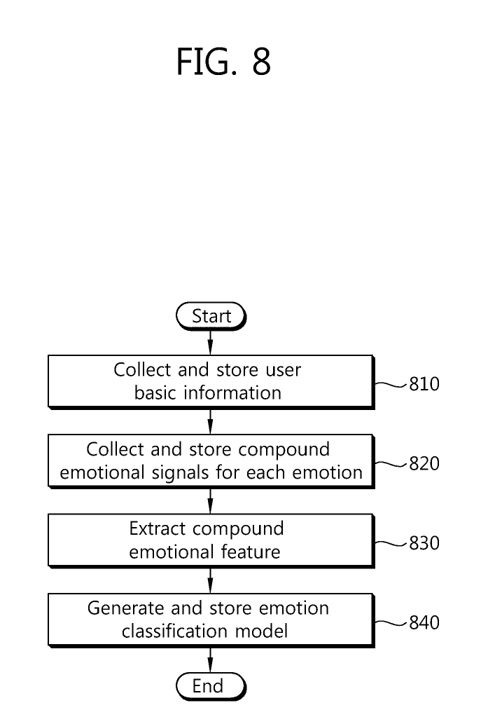

FIG. 8 is a flow diagram illustrating a method for initializing an emotional knowledgebase according to one embodiment of the present invention.

With reference to FIG. 8, while a sensing devices provides the user with a stimulus such as music, picture, and image inducing a particular emotion (for example, universal emotion such as happiness and sadness) during initialization of an emotional knowledgebase and the user exhibits the corresponding emotion, an apparatus for sensory media play receives a compound emotional signal including an image, voice, and biometric signal, and based on the received compound emotional signal, the apparatus extracts user basic information including gender and age of the user and stores the user basic information into a sensory-emotional knowledgebase 810; and at the same time, the apparatus stores the received compound emotional signal 820. Subsequently, the apparatus extracts compound emotional features which represent characteristics of an emotion from the stored compound emotional signal, and stores the extracted compound emotional features and the corresponding emotional state pair into the emotional knowledgebase 830. And the apparatus generates an emotion classification model by estimating an empirical expression most closely approximating the relationship in association with the emotional state which is paired with the compound emotional features, stores 840 the emotion classification model into the emotional knowledgebase, and terminates the initialization procedure.

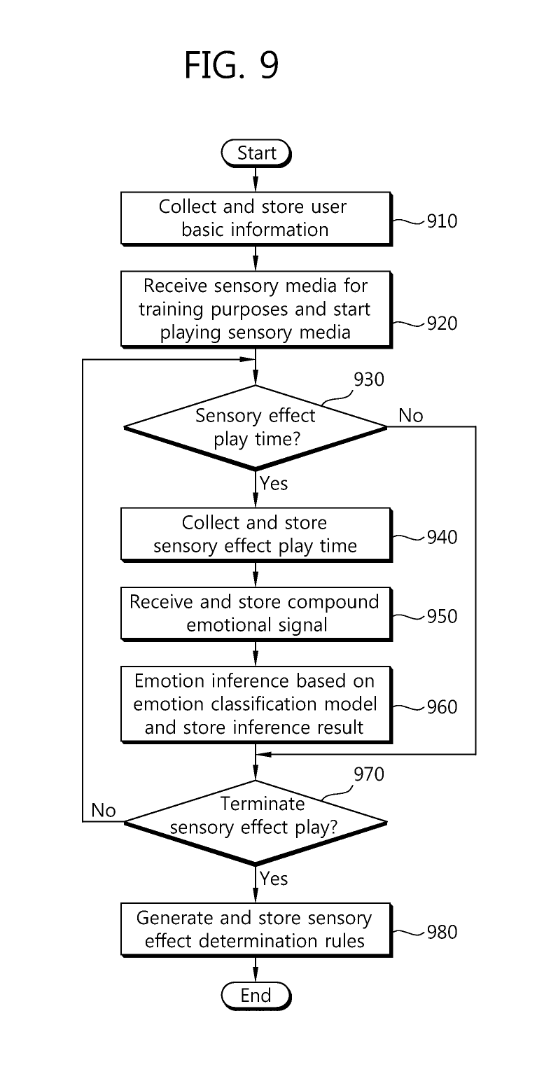

FIG. 9 is a flow diagram illustrating a method for initializing a sensory knowledgebase according to one embodiment of the present invention.

With reference to FIG. 9, an apparatus for sensory media play extracts basic information including gender and age of the user from a compound emotional signal received from a sensing device and stores the extracted basic information into the sensory-emotional knowledgebase 910. Next, the apparatus receives sensory media for training purposes including various sensory effects and starts playing the sensory media 920. Afterwards, while playing sensory media, the apparatus determines whether sensory effect play time is reached 930, and stores sensory effect play information including type, time, and strength of a played sensory effect into the sensory knowledgebase right after each sensor effect play time 940. And the apparatus receives a compound emotional signal which senses an emotional response of the user in response to a reproduced sensory effect stimulus, stores the received compound emotional signal into the sensory-emotional knowledgebase 950, infers an emotional response of the user from the received compound emotional signal based on the emotion classification model stored in the emotional knowledgebase, and stores the inference result into the sensory knowledgebase 960. Afterwards, the apparatus determines whether play of the sensory media for training purposes has been terminated and repeats the process of 930-960 until the end of sensory media play, where the apparatus keeps playing sensory effects and performs inference of an emotional response of the user experiencing the sensory effects. Finally, the apparatus generates sensory effect determination rules for the user to get a feeling of satisfaction for each type of sensory effects based on sensory effect play information stored in the sensory knowledgebase and stores the generated rules into the sensory knowledgebase 980.

Embodiments above are provided to illustrate the technical principles of the present invention; thus, it should be understood that those skilled in the art to which the present invention belongs will be able to change or modify the embodiments in various other ways unless changes or modifications of the embodiments depart from the inherent characteristics of the present invention. Therefore, those embodiments disclosed in this document are not intended to limit the technical principles of the present invention but to describe the technical principles; and the technical scope of the present invention is not limited by those embodiments. The technical scope of the present invention should be interpreted by the appended claims and all the technical principles belonging to the scope equivalent to that defined by the claims should be understood to be included in the claimed scope of the present invention.

The present invention estimates a relationship between a sensory effect and an emotional response by using emotional inference determining an emotional response of a user to a sensory effect stimulus based on a compound emotional signal obtained by sensing a user's motion, facial expression, voice, biometric signal, and so on, thereby automatically playing sensory media for the user to experience satisfaction continuously.

Therefore, the present invention improves inconvenience according as the user provides information of his or her preference for sensory effects or interacts with the sensory effects, and maximizes the effects of sensory media by playing the sensory media automatically in such a way as to meet the user satisfaction without involving the user's intentional intervention for each time the user experiences sensory effects, thereby facilitating consumption of media.

What is claimed is:

1. An apparatus for sensory media play, comprising:
a sensory media playing unit playing sensory media,
an emotion inference unit inferring an emotional state of a user based on a compound emotional signal of the user measured at the time of playing the sensory media; and
a sensory effect determining unit determining a sensory effect property of the sensory media based on the inferred emotional state of the user, where the sensory media playing unit plays the sensory media according to the sensory effect property determined.

2. The apparatus of claim 1, wherein the sensory media comprises A/V (Audio/Video) media and sensory effect metadata for playing sensory effects of the sensory media.

3. The apparatus of claim 2, wherein the sensory effect metadata includes fixed-type property information including sensory effect play time and type of a sensory effect; and variable-type property information including sensory effect play time and strength of the sensory effect.

4. The apparatus of claim 3, wherein the sensory effect determining unit determines the sensory effect property by using pre-stored sensory effect determination rules based on the estimated emotional state of the user, and generates personalized sensory effect metadata by reconfiguring variable-type property information of the sensory effect metadata based on the sensory effect property determined.

5. The apparatus of claim 3, wherein the sensory media playing unit plays the sensory media by synchronizing a sensory device playing the sensory effect based on the personalized sensory effect metadata with an A/V device playing the A/V media, and controlling the sensory device.

6. The apparatus of claim 1, wherein the emotion inference unit infers an emotional state of the user based on the compound emotional signal received at the time of playing the sensory media from a sensing device sensing at least one of motion, voice, and a biometric response of the user.

7. The apparatus of claim 6, wherein the emotion inference unit comprises a compound emotional feature extracting unit extracting compound emotional features from the compound emotional signal, an emotion classification model generating unit generating an emotion classification model estimating a relationship between the extracted compound emotional features and emotion, and an emotional response determining unit determining an emotional response of the user to a sensory effect by using the generated emotion classification model.

8. The apparatus of claim 6, wherein the emotion inference unit further comprises a user basic information extracting unit extracting basic information of a user including at least one of gender and age group of the user based on an image signal included in the compound emotional signal.

9. The apparatus of claim 7, further comprising:
an emotional knowledgebase comprising the extracted user basic information, the extracted compound emotional feature, the determined sensory response of the user to a sensory effect, and the generated emotional classification model, which is used at the time of inferring the emotional state of the user; and
an emotional knowledgebase comprising the extracted user basic information, information about sensory effects of the sensory media reproduced, information about an emotional response of the user to the sensory effects, a sensory effect determination model for determining the sensory effect, and sensory effect determination rules derived through the sensory effect determination model, which is used at the time of determining the sensory effect property.

10. A method for a sensory media playing apparatus to play sensory media, comprising:
inferring an emotional state of the user based on a compound emotional signal of the user measured at the time of playing sensory media;
determining sensory effect property of the sensory media based on the inferred emotional state of the user; and
playing the sensory media according to the sensory effect property determined.

11. The method of claim 10, wherein the sensory media comprises A/V (Audio/Video) media and sensory effect metadata for playing sensory effects of the sensory media.

12. The method of claim 11, wherein the sensory effect metadata includes fixed-type property information including sensory effect play time and type of a sensory effect; and variable-type property information including sensory effect play time and strength of the sensory effect.

13. The method of claim 12, further comprising generating personalized sensory effect metadata by reconfiguring variable-type property information of the sensory effect metadata based on the sensory effect property determined after the determining.

14. The method of claim 13, wherein the playing further comprises playing the sensory media by synchronizing a sensory device playing the sensory effect based on the personalized sensory effect metadata with an A/V device playing the A/V media and controlling the sensory device.

15. The method of claim 10, wherein the inferring infers an emotional state of the user based on the compound emotional signal received at the time of playing the sensory media from a sensing device sensing at least one of motion, voice, and a biometric response of the user.

16. The method of claim 15, wherein the inferring comprises:
extracting compound emotional features from the compound emotional signal;
generating unit generating an emotion classification model estimating a relationship between the extracted compound emotional features and emotion; and
determining an emotional response of the user to a sensory effect by using the generated emotion classification model.

17. The method of claim 10, further comprising extracting basic information of a user including at least one of gender and age group of the user based on an image signal included in the compound emotional signal prior to the inferring.

18. The method of claim 16, further comprising:
constructing an emotional knowledgebase comprising the extracted user basic information, the extracted compound emotional feature, the determined sensory response of the user to a sensory effect, and the generated emotional classification model, which is used at the time of inferring the emotional state of the user; and
constructing an emotional knowledgebase comprising the extracted user basic information, information about sensory effects of the sensory media reproduced, information about an emotional response of the user to the sensory effects, a sensory effect determination model for determining the sensory effect, and sensory effect determination rules derived through the sensory effect determination model, which is used at the time of determining the sensory effect property.
